(19) United States
(12) Patent Application Publication
(10) Pub. No.: US 2024/0381126 A1
(43) Pub. Date: Nov. 14, 2024

(54) ADDRESSING BEYOND-CP RTD FOR MULTI-RX CHAIN DL RECEPTION

(71) Applicant: Apple Inc., Cupertino, CA (US)

(72) Inventors: Xiang CHEN, Campbell, CA (US); Haitong SUN, Cupertino, CA (US); Yang TANG, San Jose, CA (US); Manasa RAGHAVAN, Sunnyvale, CA (US); Jie CUI, San Jose, CA (US); Konstantinos SARRIGEORGIDIS, Los Gatos, CA (US)

(73) Assignee: Apple Inc., Cupertino, CA (US)

(21) Appl. No.: 18/655,739

(22) Filed: May 6, 2024

Related U.S. Application Data
(60) Provisional application No. 63/465,676, filed on May 11, 2023.

(51) Int. Cl. H04W 24/02; H04L 5/00; H04W 8/22; H04W 74/04

(52) U.S. Cl. CPC H04W 24/02; H04L 5/0051; H04W 8/22; H04W 74/04

(57) ABSTRACT

Disclosed herein are system, method, and computer program product embodiments for implementing multiple receive (multi-Rx) chain downlink (DL) reception when the receive timing difference (RTD) at a user equipment (UE) from multiple transmission and reception points (TRPs) is greater than the cyclic prefix (CP). An embodiment operates by configuring a first base station (BS) to transmit a first data and a second BS to transmit a second data simultaneously to a user equipment (UE) during a first symbol period, where the first data from the first BS is received by the UE using a first receive beam and the second data from the second BS is received by the UE using a second receive beam. The embodiment also configures the first BS to transmit a reference signal (RS) to the UE during a second symbol period that is subsequent to the first symbol period. The embodiment then determines a scheduling restriction applied to the second BS during a plurality of symbol periods, wherein the plurality of symbol periods include the second symbol period. Finally, the embodiment provides the scheduling restriction the second BS.

### CROSS REFERENCES

This application claims the benefit of U.S. Provisional Application No. 63/465,676 filed May 11, 2023, titled “ADDRESSING BEYOND-CP RTD FOR MULTI-RX CHAIN DL RECEPTION,” the content of which is incorporated by reference herein in its entirety.

### BACKGROUND

### Field

The described aspects generally relate to mechanisms for coordinated downlink data reception from multiple transmission and reception points (TRPs).

### Related Art

5G New Radio (NR) supports coordinated transmission and reception from multiple TRPs, providing significant performance gains, including improved coverage, increased capacity, and enhanced spectral efficiency. Examples of multi-TRP techniques in 3GPP networks include carrier aggregation (CN), dual connectivity (DC), coordinated multi-point (CoMP), and multimedia broadcast single frequency networks (MBSFN), among others.

### SUMMARY

Some aspects of this disclosure relate to apparatuses and methods for implementing multiple receive (multi-Rx) chain downlink (DL) reception when the receive timing difference (RTD) at a user equipment (UE) from multiple TRPs is greater than the cyclic prefix (CP) (i.e., for beyond-CP RTD). For example, some aspects of this disclosure relate to imposing a downlink scheduling restriction over transmissions from one or more TRPs, based on a maximum RTD (MRTD) value to avoid inter-beam interference (IBI) including the inter-subcarrier interference (ICI).

Some aspects of this disclosure relate to a network node with a memory and a processor coupled to the memory. The processor configures a first BS to transmit a first data and a second BS to transmit a second data simultaneously to a UE during a first symbol period, where the first data from the first BS is received by the UE using a first receive beam and the second data from the second BS is received by the UE using a second receive beam. The processor then configures the first BS to transmit a reference signal (RS) to the UE during a second symbol period that is subsequent to the first symbol period. The processor then determines a scheduling restriction applied to the second BS during a plurality of symbol periods, where the plurality of symbol periods include the second symbol period. The scheduling restriction is then provided to the second BS.

According to some aspects, to configure the scheduling restriction, the processor of the network node determines, based on a determination that a third receive beam is preferred by the UE to receive the RS from the first BS, whether an interference value between the third receive beam and the second receive beam exceeds a predetermined threshold. Based on a determination that the interference value between the third receive beam and the second receive beam exceeds the predetermined threshold, the processor determines the plurality of symbol periods for applying the scheduling restriction. According to some aspects, the plurality of symbol periods are determined based on an expected MRTD value experienced by the UE with regard to the first BS and the second BS. Furthermore, the expected MRTD value is greater than a cyclic prefix corresponding to the first data and the second data, according to some aspects.

According to some aspects, to configure the first BS to transmit the first data and the second BS to transmit the second data, the processor of the network node determines whether a UE-reported MRTD capability value is greater than or equal to an expected MRTD value with regards to the first BS and the second BS. Based on a determination that the UE-reported MRTD capability value is greater than or equal to the expected MRTD value, the processor schedules the first BS to transmit the first data and the second BS to transmit the second data.

According to some aspects, the UE-reported MRTD capability is greater than a cyclic prefix duration, and the UE-reported MRTD capability value equals one of the following: (3 micro-seconds+1000 meters/C), (3 microseconds+500 meters/C), (1.5 microseconds+1000 meters/C), or (1.5 microseconds+500 meters/C), wherein C is the speed of light. According to some aspects, the UE-reported MRTD capability value is 8 milliseconds for inter-cell multi-TRPs and the UE-reported MRTD capability value is less than 8 milliseconds for intra-cell multi-TRPs. According to some aspects, the UE-reported MRTD capability value is equal to a default value to indicate that the UE only supports MRTD values that are less than a cyclic prefix duration. According to some aspect, the scheduling restriction precludes the second BS from transmitting data to the UE during the plurality of symbol periods. According to some aspects, the first data from the first BS, the second data from the second BS, and the RS from the first BS are transmitted over the same component carrier.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example wireless system implementing techniques for addressing beyond-CP RTD for multi-Rx chain DL reception, according to some aspects of this disclosure.

FIG. 2 illustrates a block diagram of an example system of an electronic device implementing techniques for addressing beyond-CP RTD for multi-Rx chain DL reception, according to some aspects of this disclosure.

FIG. 3 illustrates exemplary beam-based downlink reception at a UE from multiple BSs, according to some aspects of this disclosure.

FIGS. 4a-b illustrate examples of relative timing difference between two subframes received by a UE, according to some aspects of this disclosure.

FIG. 5 illustrates an exemplary method performed by a network node implementing multi-Rx chain DL reception when the RTD at the UE from multiple TRPs is greater than the CP (i.e., for beyond-CP RTD), according to some aspects of this disclosure.

FIG. 6 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Use case scenarios for 5G new radio (NR) include enhanced mobile broadband (eMBB), ultra-reliable low-latency communications (URLLC), and massive machine type communications (mMTC). These use cases cover a wide range of applications with highly diverse requirements. For example, eMBB is designed to cater to the large capacities needed to accommodate high user density scenarios, mMTC services are characterized by a massive number of sensors or connected devices which typically transmit low volume of non-delay sensitive data, and URLLC services refer to services that are expected to have exceptionally low latency and extremely high reliability.

5G NR systems support coordinated transmission and/or reception from multiple transmission and reception points (TRPs) to provide enhanced coverage, capacity, deployment flexibility, and overall user experience. For example, two or more TRPs can coordinate to simultaneously transmit data to a user equipment (UE), and the UE performs simultaneous downlink reception to achieve increased throughput and/or increased reception reliability.

However, signals transmitted from two or more TRPs may not arrive at the UE at the same time. The receive timing difference (RTD) between the received signals at the UE depends on the following three components: (1) the relative propagation delay difference between the received signals, (2) the timing alignment error between the transmitting TRPs, and (3) the difference between the values of the multipath delay spread experienced by the received signals.

Also, a UE with a single receive chain may not be capable of effectively processing the signals received from multiple TRPs when the maximum RTD (MRTD) between the signals exceeds the length of the cyclic prefix. In contrast, a UE with multiple RF receive chains (multi-Rx chain) may be capable of handling an MRTD value that exceeds the length of the cyclic prefix. However, the signals received from two or more TRPs over a common component carrier may interfere with each other at the UE. Furthermore, when the MRTD is greater than the length of the cyclic prefix, data over multiple symbols may experience uncorrectable interference resulting in increased error rates.

To address the above technological issue, embodiments herein provide techniques for coordinated transmission from multiple TRPs when MRTD is greater than the cyclic prefix. Some aspects of this disclosure relate to preemptively avoiding interference by configuring a scheduling restriction over one or more symbol periods that are likely to experience interference.

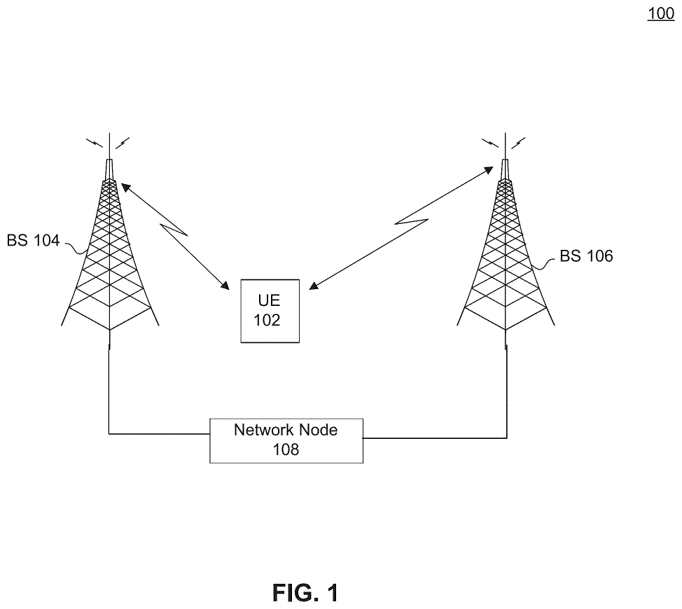

FIG. 1 illustrates an exemplary wireless system 100 implementing techniques for addressing beyond-CP RTD for multi-Rx chain DL reception, according to some aspects of this disclosure. Specifically, the exemplary wireless system 100 implements coordinated transmission from multiple TRPs when the MRTD experienced at UE 102 from transmission of the multiple TRPs is greater than the CP duration, according to some aspects of the disclosure. The example wireless system 100 is provided for the purpose of illustration only and does not limit the disclosed aspects. Wireless system 100 may include, but is not limited to, user equipment 102, base stations 104 and 106, and a network node 108, also called a network control node.

According to some aspects, the network node 108 is separate from BSs 104 and 106, and the network node 108 connects to BSs 104 and 106 using a wired link and/or a wireless link. Alternatively, or in addition, the network node 108 can be implemented as a component of BS 104 and/or BS 106. According to some aspects, network node 108 can be implemented as a distributed function among multiple network nodes. Alternatively, or in addition, network node 108 can be implemented as a distributed function among multiple BSs and/or network nodes.

According to some aspects, base station (BS) 104 and BS 106 can be a fixed station or a mobile station. BS 104 and BS 106 may be referred to as a transmission and reception point (TRP), a cellular IoT base station, an evolved NodeB (eNB), a next-generation eNB (ng-eNB), a 5G node B (NB), or some other equivalent terminology. In some examples, BS 104 and BS 106 can be interconnected to one another and/or to other base stations or network nodes in a network through various types of backhaul interfaces such as a direct physical connection, a virtual network, and/or the like, not shown.

According to some aspects, UE 102 can be configured to operate based on a wide variety of wireless communication techniques. These techniques can include, but are not limited to, techniques based on 3rd Generation Partnership Project (3GPP) standards. UE 102 can be a stationary or a mobile device. UE 102 can be a cellular phone (e.g., a smart phone), a personal digital assistant (PDA), a wireless modem, a wireless communication device, a handheld device, a laptop, a desktop, a cordless phone, a wireless local loop station, a wireless sensor, a tablet, a camera, a video surveillance camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include a robot, a drone, a location tag, and/or the like. Furthermore, UE 102 can be an augmented reality device, a virtual reality device, a mixed reality device, or the like.

According to some aspects, wireless system 100 supports multi-TRP transmissions, and UE 102 receives simultaneous transmissions from multiple BSs 104 and 106. According to some aspects, UE 102 can be configured to receive the same type of channel (e.g. PDCCH, SSB, CSI-RS) with different QCL-TypeD. According to some aspects, UE 102 can receive two separate PDSCHs from respective BSs 104 and 106. Alternatively, UE 102 can receive a common PDSCH from BS 104 and BS 106. According to some aspects, UE 102 and BSs 104 and 106 operate over frequency range 2 (e.g., 24.25 GHz to 52.6 GHZ), and UE 102 and BSs 104 and 106 can support beamforming for directional signal transmission and reception.

Furthermore, the signals transmitted from BSs 104 and 106 may arrive at the UE with an RTD. According to some aspects, a UE capability parameter includes the maximum MRTD that the UE can handle. The MRTD capability of a UE depends on the UE's implementation complexity (e.g., FFT window size, buffer size, and the like.).

According to some aspects, UE 102 reports its MRTD capability value to the network as part of the UE registration process. Also, BS 104 and/or 106 can send a UE-capability-enquiry message to request capability information from UE 102 so the network can configure UE 102 accordingly. UE 102 responds to the request with a UE-capability-information message. The UE-capability-information message is an RRC message that includes various information elements that indicate information regarding UE capability, including an MRTD capability value. According to some aspects, BS 104 and/or BS 106 receive the UE-capability-information message and forward the UE capability message information to the core network. For example, BS 104 and/or BS 106 may forward a UE radio capability information indication message to the access and mobility management function (AMF). The AMF can stores the UE capability information as part of the UE context and subsequently provides that information to other base stations.

According to some aspects, MRTD capability of UE 102 is greater than the CP duration. According to some aspects, if UE 102 does not report its MRTD capability, it indicates to the network that UE 102 only supports MRTD values that are less than CP duration (i.e., UE's MRTD capability value is less than the CP duration). Alternatively, a default value of MRTD capability can be defined. UE 102 reports the default MRTD capability value to the network to indicate to the network that UE 102 only supports MRTD values that are less than CP duration.

The MRTD between the signals received from BS 104, and the signal received from BS 106 primarily depends on the following three components: (1) the relative propagation delay difference between the two signals, (2) the timing alignment error (TAE) between BSs 104 and 106, and (3) the difference between the multipath delay spread of the channel between BS 104 to UE 102 and the channel between BS 106 to UE 102. According to some aspects, TAE values in a network may be at most 3 microseconds. Furthermore, for FR2-1 band, the propagation delay difference can be less than or equal to 5 micro-seconds for inter-band CA corresponding to a distance of 1500 meters between two neighboring BSs.

According to some aspects, UE 102 may have an MRTD capability value of 8 micro-seconds. Alternatively, UE 102 may have one of the following MRTD capability values: (3 micro-seconds+1000 meters/C), (3 microseconds+500 meters/C), (1.5 microseconds+1000 meters/C), (1.5 microseconds+500 meters/C), etc., where C is the speed of light. According to some aspects, a UE for inter-cell multi-TRP transmission may have a MRTD capability value of 8 micro-seconds, and a UE for intra-cell multi-TRP transmission may have a MRTD capability value less than 8 micro-seconds.

According to some aspects, a network node (not shown) of wireless system 100 determines an expected MRTD value based on measurements report received from various UEs in the wireless system 100.

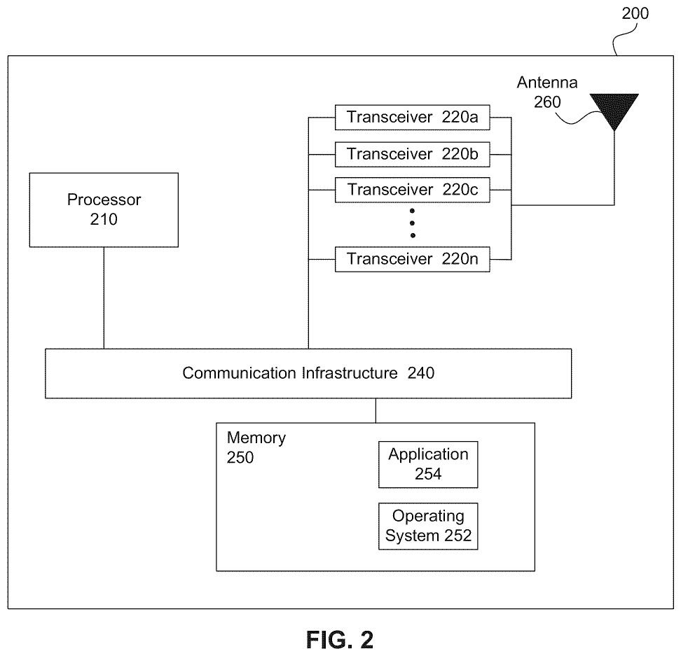

FIG. 2 illustrates a block diagram of an example system 200 of an electronic device implementing techniques for addressing beyond-CP RTD for multi-Rx chain DL reception, according to some aspects of the disclosure. System 200 may be any of the UE 102, base stations 104 or 106, or network node 108 of system 100. System 200 includes processor 210, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to, radio streaming, video streaming, remote control, and/or other user applications.

System 200 can also include communication infrastructure 240. Communication infrastructure 240 provides communication between, for example, processor 210, one or more transceivers 220a-220n, and memory 250. In some implementations, communication infrastructure 240 may be a bus. Processor 210 together with computer instructions stored in memory 250 performs operations enabling system 200 of system 100 to implement techniques for addressing beyond-CP RTD for multi-Rx chain DL reception, according to some aspects of the disclosure, as described herein. Alternatively, processor 210 can be “hard-coded” to implement techniques for addressing beyond-CP RTD for multi-Rx chain DL reception, as described herein.

One or more transceivers 220a-220n transmit and receive communications signals corresponding to the techniques for addressing beyond-CP RTD for multi-Rx chain DL reception, according to some aspects, and may be coupled to antenna 260. Antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, amplifiers, filters, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a cellular subsystem, a WLAN subsystem, and/or a Bluetooth™ subsystem, each including its own radio transceiver and protocol(s) as will be understood by those skilled arts based on the discussion provided herein. In some implementations, one or more transceivers 220a-220n can include more or fewer systems for communicating with other devices.

In some examples, one or more transceivers 220a-220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, one or more transceivers 220a-220n can include one or more circuits (including a cellular transceiver) for connecting to and communicating on cellular networks such as 5G NR and the like. For example, one or more transceivers 220a-220n can be configured to operate according to one or more of Rel-15, Rel-16, Rel-17, or other of the 3GPP standards.

Additionally, for network node 108, the system 200 can further include a network interface (not shown) to enable wired or wireless communication between network node 108 and the first and second base stations 104 and 106.

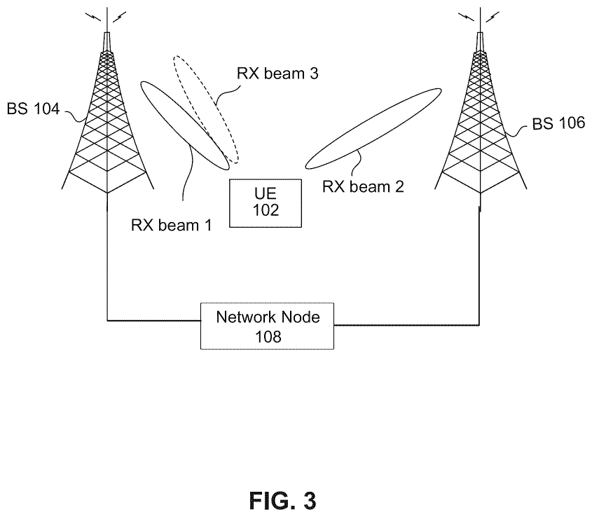

FIG. 3 illustrates beam-based downlink reception at UE 102 from BSs 104 and 106, according to some aspects of this disclosure. According to some aspects, when the MRTD capability reported by UE 102 is greater than or equal to the expected MRTD value, UE 102 can be scheduled with simultaneous DL reception from different directions with different quasi co-located (QCL) Type-D reference signals (RSs) on a single component carrier. According to some aspects, the expected MRTD value can be greater than the CP duration. In the example of FIG. 3, when the MRTD capability reported by UE 102 is greater than or equal to the expected MRTD value with regards to BS 104 and BS 106, and therefore, UE 102 is scheduled to receive simultaneous transmissions from BS 104 and BS 106 over a common component carrier.

According to some aspects, UE 102 communicates with BSs 104 and 106 over frequency range 2 (e.g., 24.25 GHz to 52.6 GHZ). UE 102 and BSs 104 and 106 operating in FR2 can utilize analog-domain beam control techniques (e.g., beam control based on phase shifters, and the like). Alternatively or additionally, UE 102 and BSs 104 and 106 may use digital-domain beamforming techniques (e.g., precoding techniques and the like).

Furthermore, during the initial beam establishment, UE 102 determines receive beam (Rx beam) 1 to be a suitable beam for the reception of downlink transmission from BS 104, and Rx beam 2 to be a suitable beam for the reception of downlink transmission from BS 106. Accordingly, the network node 108 configures UE 102 to receive data from BSs 104 and 106 simultaneously over a common component carrier. UE 102 then enters a data reception mode with BSs 104 and 106 and receives data from BS 104 using Rx beam 1 and receives data from BS 106 using Rx beam 2.

Subsequently, the network node 108 may configure UE 102 to perform layer 1 measurement of a reference signal (RS) (e.g., demodulation reference signal (DMRS), channel state information RS (CSI-RS), and the like) transmitted from BS 104. UE 102 may then enter a RS/data mode with BSs 104 and 106, and performs a beam sweep to identify a suitable Rx beam to receive the RS from BS 104. In the example of FIG. 3, UE 102 performs a beam sweep and identifies Rx beam 3 to be a suitable beam for the reception of RS from BS 104. Once the initial receive beam is established, UE 102 regularly re-evaluates the selection of the receiver-side and transmitted-side beam directions due to movements of the devices or changes in the propagation environment.

However, since UE 102 is receiving simultaneous transmissions from BSs 104 and 106 over a common component carrier, receiving the two signals over certain beam pairs may result inter-beam interference (IBI) at UE 102, according to some aspects. In the example of FIG. 3, the RS received from BS 104 using Rx beam 3 strongly interferes with data from BS 106 using Rx beam 2. As a result, data received over certain symbol periods from BS 106 may experience uncorrectable interference resulting in increased symbol error rates.

According to some aspects, UE 102 can measure the interference between two or more Rx beams and report it to the network. For example, UE 102 measures the IBI between RS received using Rx beam 3 and signals received using Rx beam 2, and sends a measurement report to the network node 108 via BSs 104 and 106. According to some aspects, based on the received measurement report, the network may impose a downlink scheduling restriction to avoid IBI over subsequent transmissions. According to some aspects, network node 108 evaluates whether the IBI between Rx beams 2 and 3 exceeds a predetermined threshold, and configures a scheduling restriction on certain subframe symbol periods of BS 106 to avoid further IBI based on the current IBI exceeding the predetermined threshold. According to some aspects, the network assumes that the IBI between Rx beams 1 and 2 is at an acceptable level and they can be used simultaneously without causing severe IBI to each other, as they were previously reported by UE, e.g., via group-based beam reporting. Furthermore, the network may assume there is scheduling restriction for any pair of RX beams if they have not been reported by the UE, e.g., Rx beams 2 and 3.

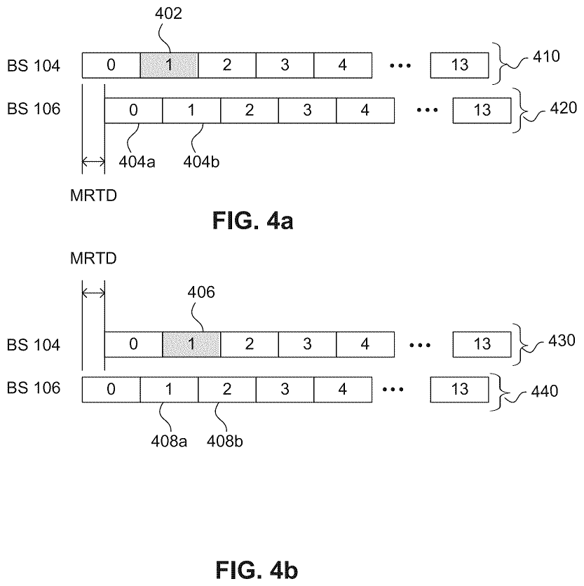

FIGS. 4a and 4b illustrate examples of relative timing difference between two subframes received by UE 102, according to some aspects of this disclosure. In the examples of FIGS. 4a and 4b, subframe 410 is received from BSs 104 and subframe 420 is received from BS 106. FIGS. 4a and 4b illustrate only a portion (i.e., 14 symbol periods) of subframes 410, 420, 430, and 440, for ease of illustration and not as a limitation.

FIG. 4a illustrates the case where subframe 410 transmitted from BS 104 arrives at UE 104 ahead of subframe 420 transmitted from BS 106 (i.e., subframe 410 is the leading subframe). Furthermore, the relative timing difference between subframes 410 and 420 equals the expected MRTD value. According to some aspects, the expected MRTD value is determined by the network based on measurements report received from various UEs.

According to some aspects, when subframe 410 is the leading subframe, and the expected MRTD value is less than one symbol duration, an RS transmitted by BS 104 can interfere with two symbol periods of subframe 420. Specifically, when the expected MRTD value is less than or equal to one symbol duration (i.e., ┌MRTD/symbol_duration┐=1, where the ceiling operator ┌X┐ outputs the smallest integer that is no less than X), an RS transmitted by BS 104 during symbol period X of subframe 410 can overlap in time with symbol periods X−1 and X of subframe 420 causing IBI. In the example of FIG. 4a, RS 402 transmitted during symbol period 1 of subframe 410 overlaps with symbol periods 0 and 1 of subframe 420. Hence, data transmitted by BS 106 during symbol periods 0 and 1 (404a and 404b) may experience uncorrectable interference from RS 402 of subframe 410, resulting in increased error rates.

According to some aspects, to preemptively avoid IBI, network node 108 determines the symbol periods of subframe 420 that may experience IBI from RS 402 of subframe 410, and imposes a scheduling restriction over those symbol periods. Specifically, when the MRTD value is less than one symbol duration, and subframe 410 is the leading subframe, network node 108 determines the symbol period over which BS 104 is configured to transmit RS to UE 102. Based on a determination that BS 104 is configured to transmit RS to UE 102 over symbol period X of subframe 410, the network node imposes a scheduling restriction on symbol periods X−1 and X of subframe 420 to avoid IBI with symbol 402 at the UE 102. According to some aspects, due to the scheduling restriction, BS 106 does not configure any data transmission to UE 102 during symbol periods X−1 and X of subframe 420.

FIG. 4b illustrates the case where subframe 440 transmitted from BS 106 arrives at UE 104 ahead of subframe 430 transmitted from BS 104 (i.e., subframe 430 is the lagging subframe). Furthermore, the relative timing difference between subframes 430 and 440 equals the expected MRTD value. According to some aspects, when subframe 430 is the lagging subframe and the expected MRTD value is less than one symbol duration, an RS transmitted by BS 104 can interfere with two symbol periods of subframe 440. Specifically, when the expected MRTD value is less than or equal to one symbol duration (i.e., ┌MRTD/symbol_duration┐=1), an RS transmitted by BS 104 during symbol period X of subframe 430 can overlap in time with symbol periods X and X+1 of subframe 440 causing IBI. In the example of FIG. 4b, RS 406 transmitted during symbol period 1 of subframe 430 overlaps with symbol periods 1 and 2 of subframe 420. Hence, data transmitted by BS 106 during symbol periods 1 and 2 (408a and 408b) may experience uncorrectable interference from RS 402 of subframe 430, resulting in increased error rates.

According to some aspects, to preemptively avoid IBI, network node 108 determines the symbol periods of subframe 440 that may experience IBI from RS 406 of subframe 430, and imposes a scheduling restriction over those symbol periods. Specifically, when the MRTD value is less than one symbol duration and subframe 430 is the lagging subframe, network node 108 determines the symbol period over which BS 104 is configured to transmit RS to UE 102. Based on a determination that BS 104 is configured to transmit RS to UE 102 over symbol period X of subframe 430, the network node 108 imposes a scheduling restriction on symbol periods X and X+1 of subframe 440 to avoid IBI with RS 406 at UE 102. According to some aspects, due to the scheduling restriction, BS 106 does not configure any data transmission to UE 102 during symbol periods X and X+1 of subframe 440.

According to some aspects, the MRTD value at UE 102 can be greater than equal multiple symbol durations (i.e., ┌MRTD/symbol_duration┐=M>1). When the expected MRTD value equals multiple symbol durations (e.g., M symbol durations), transmissions from BS 104 may be spread over several symbol durations by the time they arrive at UE 102.

Referring to FIG. 4a, according to some aspects, when the expected MRTD value equals M symbol durations, an RS transmitted by BS 104 can interfere with up to M symbol periods of subframe 420. To preemptively avoid IBI, network node 108 can impose scheduling restrictions on symbol periods of subframe 420 that may experience IBI from RS 402 of subframe 410, according to some aspects. To avoid IBI, BS 106 does not configure any data transmissions to UE 102 during the symbol periods with a scheduling restriction.

According to some aspects, when the MRTD value equals M symbol durations and subframe 410 is the leading subframe, and when BS 104 is configured to transmit RS over symbol period X of subframe 410, the network node 108 can impose a scheduling restriction on symbol periods X−1 to X+M of subframe 420 to avoid IBI. According to some aspects, when the MRTD value equals M symbol durations and subframe 410 is the lagging subframe, and when BS 104 is configured to transmit RS over symbol period X of subframe 410, the network node 108 can impose a scheduling restriction on symbol periods X to (X+M+1) of subframe 420 to avoid IBI.

According to some aspects, when the MRTD value equals M symbol durations and when BS 104 is configured to transmit RS over symbol period X of subframe 410, the network node 108 can impose a scheduling restriction on symbol periods X−M to X+M of subframe 420 to avoid IBI.

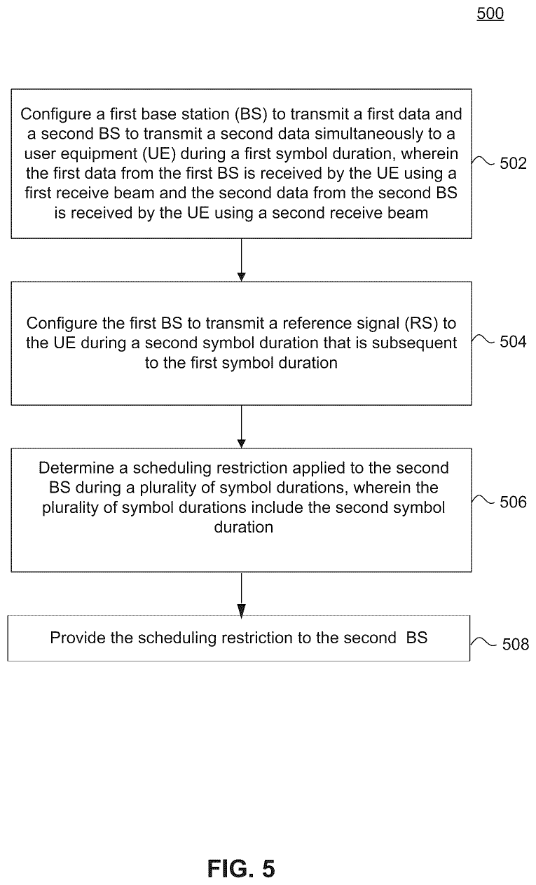

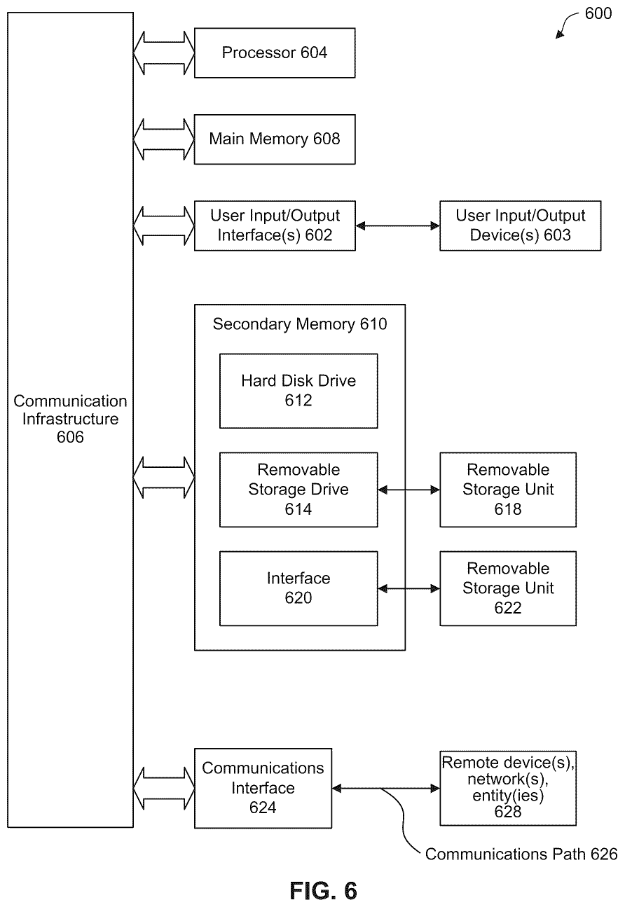

FIG. 5 illustrates an exemplary method 500 performed by a network node 108 (e.g., a BS and/or a network node of the core network) that implements multi-Rx chain DL reception when the RTD at the UE 102 from multiple TRPs is greater than the CP (i.e., for beyond-CP RTD). As a convenience and not a limitation, FIG. 5 may be described with regard to elements of FIGS. 1-4 and 6, for example by any one of the network node 108, BS 104, or BS 106. Method 500 may also be performed by system 200 of FIG. 2 and/or computer system 600 of FIG. 6. But method 500 is not limited to the specific aspects depicted in those figures, and other systems may be used to perform the method as will be understood by those skilled in the art. It is to be appreciated that not all operations may be needed, and the operations may not be performed in the same order as shown in FIG. 5.

At 502, the network node 108 configures BSs 104 and 106 to transmit simultaneously to UE 102 during a first symbol period, where the data from BS 104 is received by UE 102 using Rx beam 1 and the data from BS 106 is received by UE 102 using Rx beam 2. According to some aspects, to configure BSs 104 and 106 to transmit to UE 102, the network node 108 determines whether a UE-reported MRTD capability value is greater than or equal to an expected MRTD value with regards to BSs 104 and 106. According to some aspects, the expected MRTD value can be determined by the network based on measurement reports received from various UEs in the network. According to some aspects, UE 102 estimates the RTD between the subframes received from BSs 104 and 106, and reports the timing difference value to the network. According to some aspects, UE can provide measurement results to the network using an RRC measurement report message. According to some aspects, network node 108 can determine the expected MRTD value based on the uplink transmissions received from UE 102 by BSs 104 and 106. If the UE-reported MRTD capability value is greater than or equal to the expected MRTD value, the network node schedules BSs 104 and 106 to transmit simultaneously to UE 102. Furthermore, UE 102 is scheduled to receive simultaneous transmissions from BS 104 and BS 106 over a common component carrier.

According to some aspects, the UE-reported MRTD capability is greater than a cyclic prefix duration, and the UE-reported MRTD capability value equals one of the following: (3 micro-seconds+1000 meters/C), (3 microseconds+500 meters/C), (1.5 microseconds+1000 meters/C), or (1.5 microseconds+500 meters/C), wherein C is the speed of light. According to some aspects, the UE-reported MRTD capability value can be 8 milliseconds for inter-cell multi-TRPs, and the UE-reported MRTD capability value can be less than 8 milliseconds for intra-cell multi-TRPs. According to some aspects, the UE-reported MRTD capability value is equal to a default value to indicate that the UE only supports MRTD values that are less than a cyclic prefix duration. According to some aspects, a UE does not report a MRTD capability value to indicate that it only supports MRTD values that are less than a cyclic prefix duration.

At 504, the network node 108 configures BS 104 to transmit a RS (e.g., DMRS, CSI-RS, and the like) to UE 102 during a second symbol period that is subsequent to the first symbol period. According to some aspects, UE 102 performs a beam sweep to identify a suitable Rx beam to receive the RS from BS 104. According to some aspects, UE 102 is scheduled to receive RS from BS 104 and data BS 106 over a common component carrier.

At 506, the network node determines a scheduling restriction applied to the BS 106 during a plurality of symbol periods, wherein the plurality of symbol periods include the second symbol period. According to some aspects, to configure the scheduling restriction, network node 108 determines whether an interference value between the third receive beam and the second receive beam exceeds a predetermined threshold. According to some aspects, the predetermined threshold can correspond to an interference value above which the symbol error rate does not satisfy a quality of service requirement. According to some aspects, the interference value can be determined based on the signal to interference and noise ratio (SINR) measurements made at UE 102 on the third receive beam and the second receive beam. According to some aspects, UE can provide the SINR measurement results to the network using an RRC measurement report message. According to some aspects, the network assumes that the IBI between Rx beams 1 and 2 is at an acceptable level and they can be used simultaneously without causing severe IBI to each other, as they were previously reported by UE, e.g., via group-based beam reporting. Furthermore, the network may assume there is scheduling restriction for any pair of RX beams if they have not been reported by the UE, e.g., Rx beams 2 and 3. Network node 108 determines the symbol periods and applies the scheduling restriction when the interference value between the third receive beam and the second receive beam exceeds the predetermined threshold.

According to some aspects, when BS 104 is configured to transmit RS to UE 102 over symbol period X of a subframe of BS 104, the network node 108 imposes a scheduling restriction on symbol periods X−1 and X of a subframe of BS 106 to avoid IBI. Due to the scheduling restriction, BS 106 does not configure any data transmission to UE 102 during symbol periods X−1 and X of the subframe of BS 106. Referring back to the example of FIG. 4a, BS 104 is configured to transmit RS 402 to UE 102 over symbol period 1 of the subframe 410, and network node 108 imposes a scheduling restriction on symbol periods 0 and 1 of the subframe 420 to avoid IBI.

According to some aspects, when BS 104 is configured to transmit RS to UE 102 over symbol period X of a subframe of BS 104, the network node 108 imposes a scheduling restriction on symbol periods X and X+1 of a subframe of BS 106 to avoid IBI. Due to the scheduling restriction, BS 106 does not configure any data transmission to UE 102 during symbol periods X and X+1 of the subframe of BS 106. Referring back to the example of FIG. 4b, BS 104 is configured to transmit RS 406 to UE 102 over symbol period 1 of a subframe 430, and network node 108 imposes a scheduling restriction on symbol periods 1 and 2 of a subframe 440 to avoid IBI.

At 508, the scheduling restriction is provided to the second BS. According to some aspects, the scheduling restriction precludes the second BS from transmitting data to UE 102 during the restricted symbol periods. Referring back to the examples of FIGS. 4a and 4b, due to the scheduling restriction, BS 106 is precluded from transmitting data to UE 102 during symbol periods 0 and 1 of the subframe 420 and during symbol periods 1 and 2 of the subframe 440.

Various aspects can be implemented, for example, using one or more computer systems, such as computer system 600 shown in FIG. 6. Computer system 600 can be any well-known computer capable of performing the functions described herein such as UE 102 of FIG. 1. Computer system 600 includes one or more processors (also called central processing units, or CPUs), such as a processor 604. Processor 604 is connected to a communication infrastructure 606 (e.g., a bus). Computer system 600 also includes user input/output device(s) 603, such as monitors, keyboards, pointing devices, etc., that communicate with communication infrastructure 606 through user input/output interface(s) 602. Computer system 600 also includes a main or primary memory 608, such as random access memory (RAM). Main memory 608 may include one or more levels of cache. Main memory 608 has stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to some aspects, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 600, main memory 608, secondary memory 610 and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 6. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A network node, comprising:
a memory; and
a processor coupled to the memory and configured to:
configure a first base station (BS) to transmit a first data and a second BS to transmit a second data simultaneously to a user equipment (UE) during a first symbol period, wherein the first data from the first BS is received by the UE using a first receive beam and the second data from the second BS is received by the UE using a second receive beam;
configure the first BS to transmit a reference signal (RS) to the UE during a second symbol period that is subsequent to the first symbol period;
determine a scheduling restriction applied to the second BS during a plurality of symbol periods, wherein the plurality of symbol periods include the second symbol period; and
provide the scheduling restriction to the second BS.

2. The network node of claim 1, wherein to configure the scheduling restriction, the processor circuitry is further configured to:
determine, based on a determination that a third receive beam is preferred by the UE to receive the RS from the first BS, whether an interference value between the third receive beam and the second receive beam exceeds a predetermined threshold; and
based on a determination that the interference value between the third receive beam and the second receive beam exceeds the predetermined threshold, determine the plurality of symbol periods for applying the scheduling restriction.

3. The network node of claim 1, wherein the plurality of symbol periods are determined based on an expected maximum receive time delay (MRTD) value experienced by the UE with regards to the first BS and the second BS.

4. The network node of claim 3, wherein the expected MRTD value is greater than a cyclic prefix corresponding to the first data and the second data.

5. The network node of claim 1, wherein, to configure the first BS to transmit the first data and the second BS to transmit the second data, the processor circuitry is further configured to:
determine whether a UE-reported MRTD capability value is greater than or equal to an expected MRTD value with regards to the first BS and the second BS; and
based on a determination that the UE-reported MRTD capability value is greater than or equal to the expected MRTD value, schedule the first BS to transmit the first data and the second BS to transmit the second data.

6. The network node of claim 5, wherein the UE-reported MRTD capability is greater than a cyclic prefix duration, and wherein the UE-reported MRTD capability value equals one of the following: (3 micro-seconds+1000 meters/C), (3 microseconds+500 meters/C), (1.5 microseconds+1000 meters/C), or (1.5 microseconds+500 meters/C), wherein C is the speed of light.

7. The network node of claim 5, wherein the UE-reported MRTD capability value is 8 milliseconds for inter-cell multi-TRPs and the UE-reported MRTD capability value is less than 8 milliseconds for intra-cell multi-TRPs.

8. The network node of claim 5, wherein the UE-reported MRTD capability is a default value to indicates the UE only supports MRTD values that are less than a cyclic prefix duration.

9. The network node of claim 1, wherein the scheduling restriction precludes the second BS from transmitting data to the UE during the plurality of symbol periods.

10. The network node of claim 1, wherein the first data from the first BS and the second data from the second BS are transmitted over a same component carrier.

11. The network node of claim 10, wherein the RS is transmitted from the first BS over the same component carrier.

12. A method of operating a network, comprising:
configuring a first base station (BS) to transmit a first data and a second BS to transmit a second data simultaneously to a user equipment (UE) during a first symbol period, wherein the first data from the first BS is received by the UE using a first receive beam and the second data from the second BS is received by the UE using a second receive beam;
configuring the first BS to transmit a reference signal (RS) to the UE during a second symbol period that is subsequent to the first symbol period;
determining a scheduling restriction applied to the second BS during a plurality of symbol periods, wherein the plurality of symbol periods include the second symbol period; and
providing the scheduling restriction to the second BS.

13. The method of claim 12, wherein, the configuring the scheduling restriction further comprises:
determining, based on a determination that a third receive beam is preferred by the UE to receive the RS from the first BS, whether an interference value between the third receive beam and the second receive beam exceeds a predetermined threshold; and
based on a determination that the interference value between the third receive beam and the second receive beam exceeds the predetermined threshold, determining the plurality of symbol periods for applying the scheduling restriction.

14. The method of claim 12, wherein the plurality of symbol periods are determined based on an expected maximum receive time delay (MRTD) value experienced by the UE with regards to the first BS and the second BS.

15. The method of claim 14, wherein the expected MRTD value is greater than a cyclic prefix corresponding to the first data and the second data.

16. The method of claim 12, wherein, the configuring the first BS to transmit the first data and the second BS to transmit the second data, further comprises:
determining whether a UE-reported MRTD capability value is greater than or equal to an expected MRTD value with regards to the first BS and the second BS;
based on a determination that the UE-reported MRTD capability value is greater than or equal to the expected MRTD value, scheduling the first BS to transmit the first data and the second BS to transmit the second data.

17. The method of claim 12, wherein the scheduling restriction precludes the second BS from transmitting data to the UE during the plurality of symbol periods.

18. The method of claim 12, wherein the first data from the first BS and the second data from the second BS are transmitted over a same component carrier.

19. A non-transitory computer-readable medium (CRM) having instructions stored thereon that, when executed by a processor of a network node, causes the network node to perform operations comprising:
configuring a first base station (BS) to transmit a first data and a second BS to transmit a second data simultaneously to a user equipment (UE) during a first symbol period, wherein the first data from the first BS is received by the UE using a first receive beam and the second data from the second BS is received by the UE using a second receive beam;
configuring the first BS to transmit a reference signal (RS) to the UE during a second symbol period that is subsequent to the first symbol period;
determining a scheduling restriction applied to the second BS during a plurality of symbol periods, wherein the plurality of symbol periods include the second symbol period; and
providing the scheduling restriction to the second BS.

20. The non-transitory CRM of claim 19, wherein to configure the scheduling restriction, the operations further comprising:
determining, based on a determination that a third receive beam is preferred by the UE to receive the RS from the first BS, whether an interference value between the third receive beam and the second receive beam exceeds a predetermined threshold; and
based on a determination that the interference value between the third receive beam and the second receive beam exceeds the predetermined threshold, determining the plurality of symbol periods for applying the scheduling restriction.
